(19) United States
(12) Patent Application Publication
(10) Pub. No.: US 2007/0024176 A1
(43) Pub. Date: Feb. 1, 2007

(54) Electron emission display and its method of manufacture

(76) Inventors: Seung-Joon Yoo, Suwon-si (KR); Eung-Joon Chi, Suwon-si (KR); Hyoung-Cheol Seo, Suwon-si (KR)

Correspondence Address: Robert E. Bushnell, Suite 300, 1522 K Street, N.W., Washington, DC, 20005-1202, US

(21) Appl. No.: 11/488,606

(22) Filed: Jul. 19, 2006

(30) Foreign Application Priority Data
Jul. 29, 2005 (KR) 10-2005-0069427
Aug. 26, 2005 (KR) 10-2005-0078748

(51) Int. Cl. H01J 63/04

(52) U.S. Cl. 313/495; 313/496; 313/292

(57) ABSTRACT

An electron emission display includes first and second substrates facing each other, an electron emission unit provided on the first substrate, a light emission unit formed on the second substrate such that the light emission unit faces the electron emission unit, and spacers arranged between the first and second substrates. The spacers are fixed on at least one of the first and second substrates by an adhesive layer, and the adhesive layer surrounds edges of the spacers.

### CLAIM OF PRIORITY

This application makes reference to, incorporates the same herein, and claims all benefits accruing under 35 U.S.C.§119 from an application for ELECTRON EMISSION DEVICE filed in the Korean Intellectual Property Office on the of Jul. 29, 2005, and an application for ELECTRON EMISSION DEVICE AND METHOD OF MANUFACTURING THE SAME filed in the Korean Intellectual Property Office on the of Aug. 26, 2005, and there duly assigned Ser. Nos. 10-2005-0069427 and 10-2005-0078748, respectively.

### BACKGROUND OF THE INVENTION

1. Field of the Invention

The present invention relates to an electron emission display, and in particular, to an electron emission display including spacers arranged between first and second substrates to space them apart from each other.

2. Description of the Related Art

Generally, electron emission devices are classified into a first type where a hot cathode is used as an electron emission source, and a second type where a cold cathode is used as the electron emission source.

Field Emitter Array (FEA) devices, Surface Conduction Emission (SCE) devices, Metal-Insulator-metal (MIM) devices, and Metal-Insulator-Semiconductor (MIS) devices are known electron emission devices of the second type.

The MIM type and the MIS type of electron emission devices respectively have electron emission regions based on a metal/insulator/metal (MIM) structure and a metal/insulator/semiconductor (MIS) structure. When voltages are supplied to the metals or the metal and the semiconductor interposing the insulator, electrons migrate from the lower metal or semiconductor to the upper metal through the insulator by tunneling. The electrons, having an energy higher than the work function of the upper metal, are then emitted to the top thereof.

The SCE type of electron emission device includes first and second electrodes formed on a substrate while facing each other, and a conductive thin film disposed between the first and second electrodes. Micro-cracks are formed on the conductive thin film to form electron emission regions. When voltages are supplied to the electrodes while causing an electric current flow to the surface of the conductive thin film, electrons are emitted from the electron emission regions.

The FEA type of electron emission device is based on the principle that when a material having a low work function or a high aspect ratio is used as an electron emission source, electrons are easily emitted from the material due to an electric field under a vacuum atmosphere. A front sharp-pointed tip structure based on molybdenum (Mo) or silicon (Si), or a carbonaceous material such as carbon nanotubes, graphite, or diamond-like carbon, has been developed to be used as the electron emission source.

Arrays of electron emission elements are arranged on a first substrate to form an electron emission device, and assembled with a second substrate having a light emission unit including phosphor layers and an anode electrode, thereby constructing an electron emission display.

The electron emission display commonly has first and second substrates forming a vacuum vessel, and electron emission regions formed on the first substrate together with driving electrodes for controlling the emission of electrons from those electron emission regions. Phosphor layers are formed on the second substrate together with an anode electrode for effectively accelerating the electrons emitted from the side of the first substrate toward the phosphor layers. With this structure, the electron emission display emits light, or displays desired images.

With the electron emission display, a plurality of spacers are provided within the vacuum vessel. The spacers maintain a constant distance between the first and second substrates, and prevent the substrates from being distorted and broken due to pressure applied to the vacuum vessel.

The spacers are commonly formed of a glass or ceramic material, and are attached to the top of the structure of the first substrate or to the top of the structure of the second substrate by way of an adhesive layer.

The electron emission display, particularly the FEA type where electrons are emitted under the application of electric fields, can be fluidly operated only when the interior thereof is electrically stabilized. The electrically stabilized state refers to a state wherein an abnormal discharge such as arcing does not occur within the vacuum vessel.

However, with the structure where the spacer is fixed using the adhesive layer, the adhesive layer exists only at the interface between the spacer and the structure of the first substrate. Accordingly, the edge of the spacer is exposed to the interior of the vacuum vessel.

Electrical fields are locally concentrated at the edges of the spacers so that arcing can easily occur. The arcing seriously occurs at a wall type of spacer with a long edge and a large surface area exposed to the vacuum atmosphere.

Consequently, with such an electron emission display, the application of a high voltage to the anode electrode is limited so that it is difficult to increase the brightness.

Furthermore, with the structure where the spacer is fixed by the adhesive layer, the adhesive layer is liable to spread to neighboring areas during the loading of the spacers. For instance, when the spacers are fixed on the second substrate, the adhesive layer can spread to neighboring phosphor layers, thereby contaminating them and deteriorating the display characteristic of the electron emission display.

### SUMMARY OF THE INVENTION

It is an object of the present invention to provide an electron emission display that prevents the edges of the spacers from being exposed to the interior of the vacuum vessel, thereby stopping possible arcing therein.

This and other objects can be achieved by an electron emission display where, when spacers are fixed on a substrate by an adhesive layer, structural components placed around the spacers are prevented from being damaged.

According to one aspect of the present invention, an electron emission display is provided including: first and second substrates spaced apart and facing each other; an electron emission unit arranged on the first substrate; a light emission unit arranged on the second substrate such that the light emission unit faces the electron emission unit; and spacers arranged between the first and second substrates; the spacers are affixed to at least one of the first and second substrates by an adhesive layer; and the adhesive layer is arranged to surround edges of the spacers.

The electron emission display preferably further includes barriers arranged external to the adhesive layer. The barriers are preferably arranged at both lateral sides of each spacer in a longitudinal direction of the spacer. The barriers are preferably arranged to entirely surround a lateral surface of each spacer. The barriers preferably include an opaque material.

The adhesive layer preferably includes a base arranged between a surface of each spacer and one of the substrates, and an extension extending from the base and surrounding a lateral surface of each spacer.

The light emission unit preferably includes phosphor layers and a black layer arranged between the phosphor layers, and each spacer is arranged at an area of the black layer.

The barriers are preferably arranged to border the phosphor layers.

The electron emission unit preferably includes cathode and gate electrodes crossing each other on the first substrate and insulated from each other, and electron emission regions connected to the cathode electrodes. The gate electrodes are preferably arranged over the cathode electrodes, and the spacers are affixed by the adhesive layer over the gate electrode at a location corresponding to a non-light emission area.

The electron emission unit preferably further includes a focusing electrode arranged over the cathode and gate electrodes, and the spacers are fixed by the adhesive layer over the focusing electrode at a location corresponding to the non-light emission area.

The adhesive layer preferably includes a conductive material.

The spacers preferably include a wall or a pillar shape.

According to another aspect of the present invention, a method of manufacturing an electron emission display is provided, the method including: forming phosphor layers on a substrate such that the phosphor layers are surrounded by a non-light emission area; forming barriers on the non-light emission area such that the barriers are spaced apart from each other; forming adhesive layers on the non-light emission area surrounded by the barriers; and mounting spacers on the respective adhesive layers, and pressurizing the spacers such that the adhesive layer entirely covers a surface of the spacers and partially surrounds a lateral surface of the spacer.

The method preferably further includes forming a black layer on the non-light emission area before the formation of the phosphor layers.

The barriers are preferably formed of an opaque material. The barriers are preferably formed by one of screen printing, laminating, or doctor blade processing.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a partial exploded perspective view of an electron emission display according to a first embodiment of the present invention.

FIG. 2 is a partial sectional view of the electron emission display according to the first embodiment of the present invention.

FIG. 3 is an amplified view of the main components of the electron emission display of FIG. 2.

FIG. 4 is a partial exploded perspective view of an electron emission display according to a second embodiment of the present invention.

FIG. 5 is a partial sectional view of an electron emission display according to a third embodiment of the present invention.

FIGS. 6 and 7 are views of the pattern of the barriers.

FIGS. 8A to 8F are sectional views of the electron emission display according to the third embodiment of the present invention, illustrating the steps of manufacturing the device.

### DETAILED DESCRIPTION OF THE INVENTION

With reference to the accompanying drawings, the present invention is described in order for those skilled in the art to be able to implement it. As those skilled in the art would realize, the described embodiments can be modified in various different ways, all without departing from the spirit or scope of the present invention. Wherever possible, the same reference numbers are used throughout the drawing(s) to refer to the same or like parts.

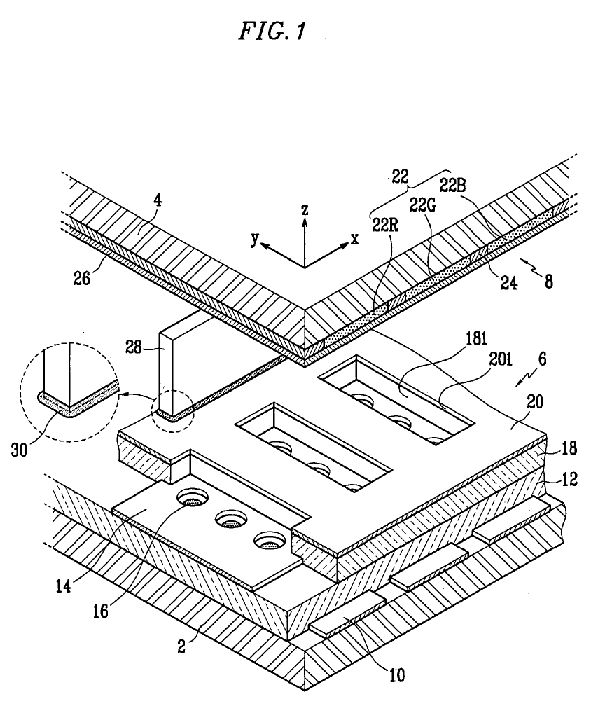

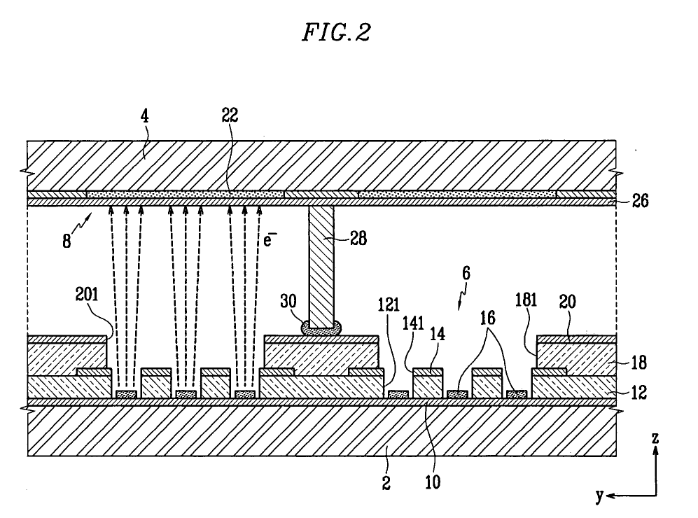

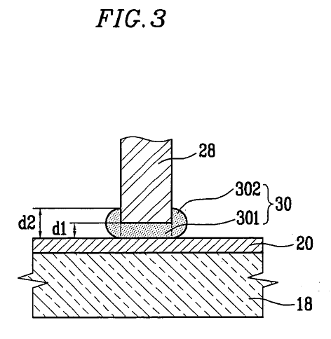

FIGS. 1 and 2 are a partial exploded perspective view and a partial sectional view of an electron emission display according to a first embodiment of the present invention, and FIG. 3 is an amplified view of the main components of the electron emission display of FIG. 2.

As shown in FIGS. 1 and 2, the electron emission display includes first and second substrates 2 and 4 spaced apart and facing each other in parallel. A side member (not shown) is mounted at the peripheries of the first and second substrates 2 and 4 to thereby construct a vacuum vessel.

An electron emission unit 6 is provided at the first substrate 2 to emit electrons toward the second substrate 4, and a light emission unit 8 is provided at the second substrate 4 to emit visible light rays due to excitement thereof by the electrons. In this embodiment, the electron emission unit and the light emission unit are of the Field Emitter Array (FEA) type.

With the electron emission unit 6, cathode electrodes 10 are stripe-patterned on the first substrate 2 in a direction of the first substrate 2 (in the y axis direction of FIG. 1), and a first insulating layer 12 is formed on the entire surface of the first substrate 2 such that it covers the cathode electrodes 10.

Gate electrodes 14 are stripe-patterned on the first insulating layer 12 perpendicular to the cathode electrodes 10 (in the x axis direction of FIG. 1).

Electron emission regions 16 are formed on the cathode electrodes 10 at respective crossed regions of the cathode and gate electrodes 10 and 14. Opening portions 141 and 121 are formed at the gate electrodes 14 and the first insulating layer 12 to expose the electron emission regions 16 on the first substrate 2.

A second insulating layer 18 and a focusing electrode 20 are sequentially formed on the gate electrodes 14 and the first insulating layer 12. Opening portions 181 and 201 are formed at the second insulating layer 18 and the focusing electrode 20 such that one opening portion is provided at each pixel, and the focusing electrode 20 collectively focuses the electrons emitted from each pixel.

While, as noted above, the gate electrodes 14 are placed over the cathode electrodes 10 while interposing the first insulating layer 12, it is possible for the gate electrodes are placed under the cathode electrodes. In this structure, the electron emission regions can be formed on the first insulating layer while contacting a lateral surface of the cathode electrodes.

While the electron emission display of the present embodiment is provided with a focusing electrode, the focusing electrode can be omitted depending upon the degree of diffusion of the electron beams.

The electron emission regions 16 are formed with a material for emitting electrons under the application of an electric field, such as a carbonaceous material or a nanometer-sized material. Alternatively, the electron emission regions can be formed with a sharp-pointed tip structure mainly of molybdenum Mo or silicon Si.

The light emission unit 8 includes phosphor layers 22 formed on the second substrate 4, a black layer 24 disposed between the respective phosphor layers 22, and an anode electrode 26 formed on the phosphor layers 22 and the black layer 24 with a metallic material, such as aluminum (Al).

The phosphor layers 22 can be formed with red phosphor layers 22R, green phosphor layers 22G, and blue phosphor layers 22B. The anode electrode 26 receives a high voltage required for accelerating the electron beams from the outside, and reflects the visible light rays radiated by the phosphor layers 22 to the first substrate 2 toward the second substrate 4, thereby increasing the screen brightness.

Alternatively, the anode electrode can be formed with a transparent material, such as Indium Tin Oxide (ITO) instead of the metallic material. In this case, the anode electrode is placed on a surface of the phosphor and black layers directed toward the second substrate.

The electron emission unit 6 and the light emission unit 8 discussed above are part of an FEA device. However, the present invention is not limited thereto. That is, the electron emission unit and the light emission unit can be part of an Surface Conduction Emission (SCE) device, a Metal-Insulator-metal (MIM) device, or a Metal-Insulator-Semiconductor (MIS) device.

A plurality of spacers 28 are arranged between the first and the second substrates 2 and 4 to space them apart from each other. The spacers 28 are placed at the non-light emission area of the black layer 24 such that they do not interrupt the electrons proceeding toward the phosphor layers 22. FIG. 1 exemplifies wall-type spacers.

The spacers 28 are fixed on at least one of the first and second substrates 2 and 4 by way of adhesive layers 30. Specifically, each spacer 28 is fitted between the electron emission unit 6 formed on the first substrate 2 and the light emission unit 8 formed on the second substrate 4 due to the adhesion of the adhesive layer 30. With the electron emission display according to the embodiment of the present invention, the adhesive layer 30 is placed under the spacer 28 while contacting the electron emission unit 6.

As shown in FIG. 3, the adhesive layer 30 surrounds the edge of the spacer 28 while contacting the surface of the spacer 28. Specifically, the adhesive layer 30 has a base 301 disposed between a surface of the spacer 28 and the focusing electrode 20 to exert adhesion thereto, and an extension 302 extended upwardly from the base 301 while contacting the lateral surface of the spacer 28. The base 301 and the extension 302 are demarcated by the dotted area of FIG. 3.

The base 301 has a thickness of d1, and the adhesive layer 30 including the extension 302 has a thickness of d2. That is, d2 is established to be greater than d1 (d2>d1).

Consequently, the bottom edge of the spacer 28 is not exposed to the interior of the vacuum vessel due to the presence of the extension 302 so that the possible arcing concentrated on the edge area can be prevented.

The structure according to the embodiment of the present invention can be more effectively applied to wall-type spacers with a long edge to prevent arcing.

Furthermore, the adhesive layer 30 can contain a conductive material to guide the charges, generated at the spacer 28 due to exposure of the spacer 28 to the vacuum atmosphere for a long period of time and the collision of electrons thereto, to the outside of the display device through the focusing electrode 20.

The adhesive layer 30 is formed such that an adhesive is coated at the location to be formed with the spacer 28 with a predetermined thickness, followed by mounting the spacer 28 onto the adhesive and pressurizing it against the adhesive.

In the above process, when the spacer 28 is pressurized against the adhesive, the adhesive partially spreads around the spacer 28 due to the pressure thereof, and contacts the lateral surface of the spacer 28 to thereby form the extension 302 of the adhesive layer 30.

Accordingly, when the adhesive is first coated at the location to be formed with the spacer 28, the coating amount thereof is controlled in consideration the formation of the extension 302.

The above structure of the adhesive layer can be applied to a structure where the spacer 28 is attached to a light emission unit 8 formed on the second substrate 4, or to a structure where the electron emission display does not have the focusing electrode 20. In the latter case, the spacer can be fixed to the gate electrodes or the first insulating layer between the gate electrodes.

Particularly, when the spacer is fixed on the gate electrode, an adhesive layer containing a conductive material can be used, and in this case, the charges at the spacer are guided to the outside through the gate electrodes.

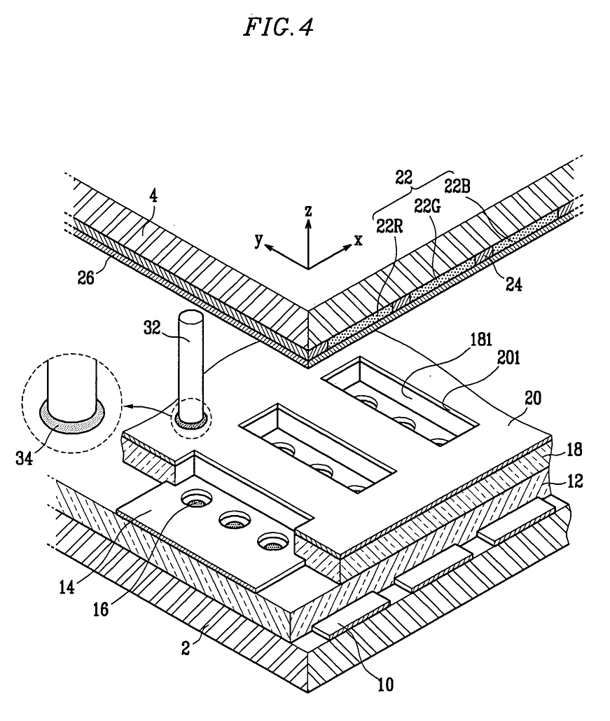

FIG. 4 is a partial exploded perspective view of an electron emission display according to a second embodiment of the present invention. As shown in FIG. 4, the electron emission display according to the second embodiment is provided with cylindrically-shaped spacers 32.

In this embodiment, the bottom edge of each cylindrically-shaped spacer 32 is externally surrounded by an adhesive layer 34, and the formation process thereof is the same as that of the previous embodiment.

The spacers can be formed of various pillar shapes with an edge, such as a rectangular prism and a cross prism.

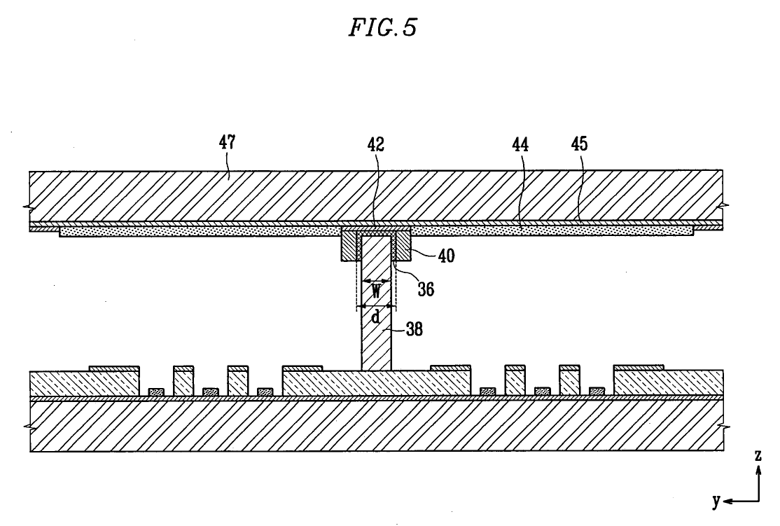

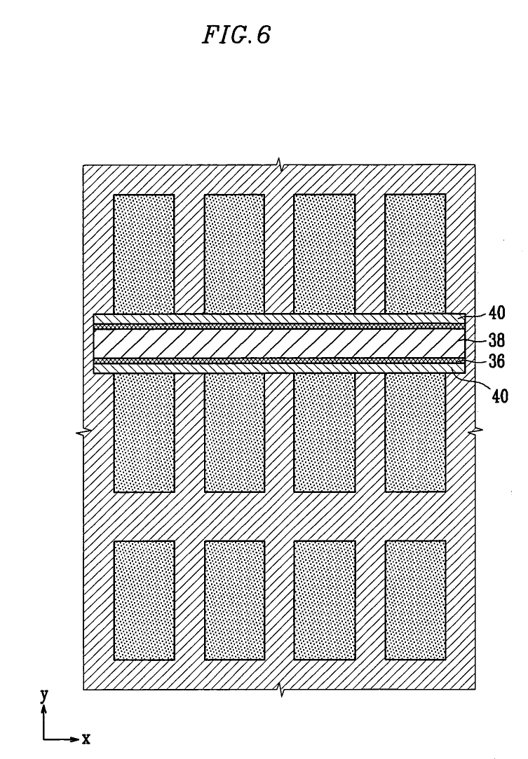

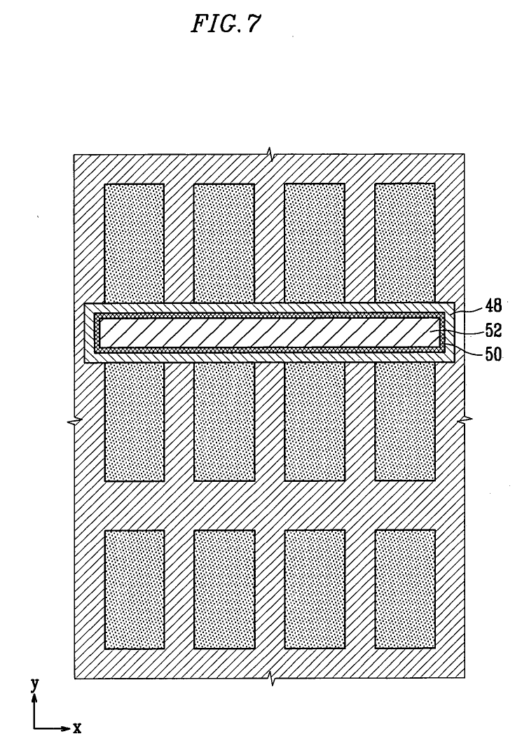

FIG. 5 is a partial sectional view of an electron emission display according to a third embodiment of the present invention, and FIGS. 6 and 7 illustrate the pattern of the barriers according to the third embodiment.

As shown in FIG. 5, the electron emission display according to the third embodiment has a barrier 40 surrounding an adhesive layer 36 such that the adhesive layer 36 does not spread around a spacer 38.

That is, in this embodiment, each spacer 38 is fixed on a second substrate 47 with a black layer 42, phosphor layers 44, and an anode electrode 45 by way of the adhesive layer 36. As with the electron emission display according to the first embodiment, each spacer 38 is formed in the shape of a wall. The spacer 38 is placed at the non-light emission area of the black layer 42.

Furthermore, in this embodiment, the phosphor layers 44 have a thickness larger than that of the black layer 42, and the anode electrode 45 is formed on a surface of the phosphor and black layers 44 and 42 and is directed toward the second substrate 47. That is, the anode electrode 45 is first formed on the second substrate 47, and the black and phosphor layers 42 and 44 are formed on the anode electrode 45.

As shown in Fig. 6, barriers 40 are placed at both lateral sides of each spacer 38 in the longitudinal direction of the spacer 38. Accordingly, the barriers 40 are formed in the shape of a bar, and a distance d between the barriers 40 facing each other is greater than the width w of each spacer 38.

The adhesive layer 36 is disposed between the spacer 38 and the barrier 40 as well as between the spacer 38 and the black layer 42 such that it covers a surface of the spacer 38 directed toward the second substrate 47 (the top surface thereof), and surrounds the edge of the spacer 38 and hence the lateral surface of the spacer 38.

With this structure, the barriers 40 are placed external to the adhesive layer 36 such that with the loading of the spacer 38, the adhesive layer 36 is prevented from spreading around the spacer 38 to the neighboring structural components, that is, to the phosphor layers 44. Moreover, the barriers 40 support the adhesive layer 36 such that the adhesive layer 36 easily covers and surrounds the top surface and the lateral surface of the spacer 38.

The barriers 40 can border the phosphor layers 44 such that the adhesive layers 36 have a sufficient spatial area within the black layer 42. The barriers 40 can be formed with an opaque material, such as graphite, such that with the usage of the electron emission display, the user does not perceive them.

FIG. 7 is a view of a variant of the barrier. As shown in FIG. 7, a barrier 48 proceeds along the periphery of a spacer 52, and entirely surrounds the lateral surface of the spacer 52 around an adhesive layer 50. With this variant, the basic structure of the barrier 48 and the adhesive layer 50 is the same as that of the third embodiment.

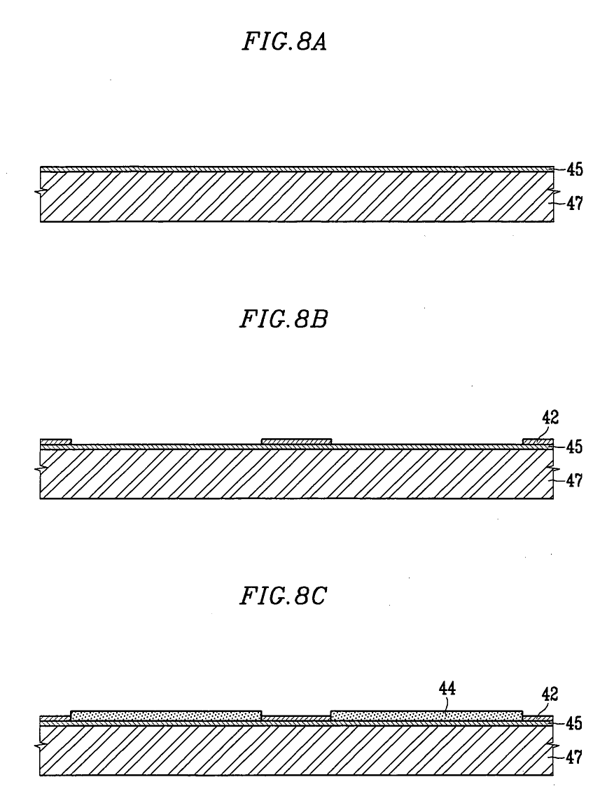

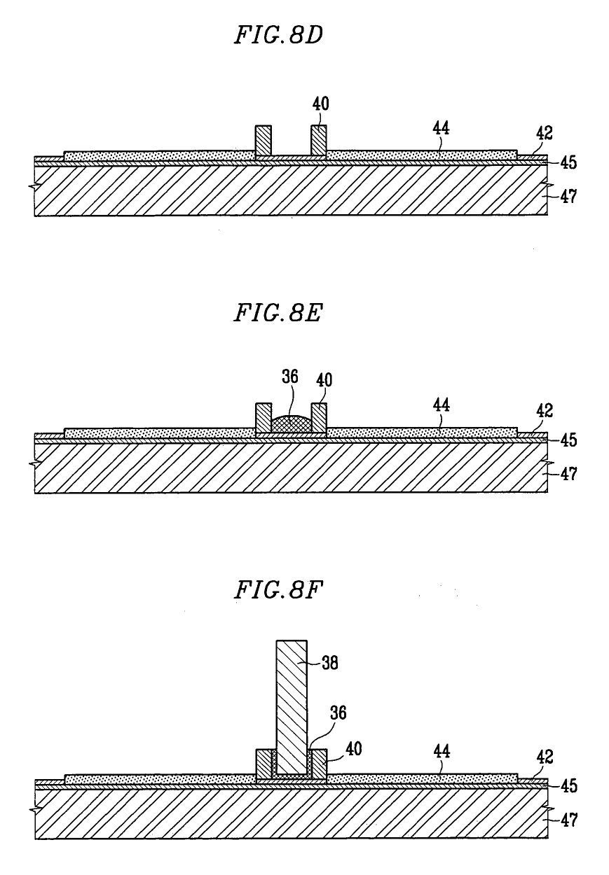

FIGS. 8A to 8F are sectional views of the electron emission display according to the third embodiment of the present invention, and illustrate the steps of manufacturing it.

Referring to FIG. 8A, an anode electrode 45 is formed on the second substrate 47 with a transparent material, such as ITO. The anode electrode 45 can be singly formed on the entire surface of the second substrate 47, or can be partitioned into a plurality of portions with a predetermined pattern.

A layer of an opaque material, such as chromium and chromium oxide. is formed on the second substrate 47 with the anode electrode 45 through a thin film formation process, such as sputtering. The layer is then patterned through photolithography and etching to thereby form a black layer 42 (Refer to FIG. 8B).

A mixture of a phosphor slurry and a photosensitive material is coated onto the second substrate 47 with the black layer 42, and is patterned through light exposing and developing to thereby form phosphor layers 44 in spaces within the black layer 42 (Refer to FIG. 8C).

A layer of an opaque material, such as graphite, is formed on the second substrate 47 with the phosphor layers 44 through a thick film process such as screen printing, laminating, or doctor blade processing. The layer is patterned through photolithography and etching to thereby form barriers 40 on the black layer 42 (Refer to FIG. 8D).

The barrier 40 has a predetermined height such that it can face a lateral surface of the spacer, to be described later, and the distance between the barriers 40 is established to be greater than the width of the spacer.

Referring to FIGS. 8E and 8F, an adhesive layer 36 is formed on the black layer 42 surrounded by the barriers 40, followed by mounting a spacer 38 on the adhesive layer 36 and pressurizing it, thereby fixing the spacer 38 to the second substrate 47.

As the adhesive layer 36 rises to the lateral surface of the spacer 38 and surrounds the spacer 38 due to the existence of the barrier 40, the adhesion of the spacer 38 is reinforced, and the adhesive layer 36 is prevented from spreading to the neighboring phosphor layers 44.

As described above, with the electron emission display according to the embodiment of the present invention, the adhesive layer surrounds the edge of the spacer so that arcing due to the concentration of the electric fields on the edge area is prevented. Consequently, limitations of high voltage applied to the anode electrode that can normally occur due to arcing are not extant.

With the electron emission display according to the embodiment of the present invention, barriers are provided external to the adhesive layer such that the adhesion between the adhesive layer and the spacer is reinforced, and the adhesive layer does not spread around the spacer to thereby prevent the phosphor layers from being contaminated.

Although exemplary embodiments of the present invention have been described in detail hereinabove, it should be clearly understood that many variations and/or modifications of the basic inventive concept taught herein will still fall within the spirit and scope of the present invention, as defined by the appended claims.

What is claimed is:

1. An electron emission display, comprising:
first and second substrates spaced apart and facing each other;
an electron emission unit arranged on the first substrate;
a light emission unit arranged on the second substrate such that the light emission unit faces the electron emission unit; and
spacers arranged between the first and second substrates;
wherein the spacers are affixed to at least one of the first and second substrates by an adhesive layer; and
wherein the adhesive layer is arranged to surround edges of the spacers.

2. The electron emission display of claim 1, further comprising barriers arranged external to the adhesive layer.

3. The electron emission display of claim 2, wherein the barriers are arranged at both lateral sides of each spacer in a longitudinal direction of the spacer.

4. The electron emission display of claim 2, wherein the barriers are arranged to entirely surround a lateral surface of each spacer.

5. The electron emission display of claim 2, wherein the barriers comprise an opaque material.

6. The electron emission display of claim 1, wherein the adhesive layer comprises a base arranged between a surface of each spacer and one of the substrates, and an extension extending from the base and surrounding a lateral surface of each spacer.

7. The electron emission display of claim 2, wherein the light emission unit comprises phosphor layers and a black layer arranged between the phosphor layers, and wherein each spacer is arranged at an area of the black layer.

8. The electron emission display of claim 7, wherein the barriers are arranged to border the phosphor layers.

9. The electron emission display of claim 2, wherein the electron emission unit comprises cathode and gate electrodes crossing each other on the first substrate and insulated from each other, and electron emission regions connected to the cathode electrodes.

10. The electron emission display of claim 9, wherein the gate electrodes are arranged over the cathode electrodes, and the spacers are affixed by the adhesive layer over the gate electrode at a location corresponding to a non-light emission area.

11. The electron emission display of claim 9, wherein the electron emission unit further comprises a focusing electrode arranged over the cathode and gate electrodes, and the spacers are fixed by the adhesive layer over the focusing electrode at a location corresponding to the non-light emission area.

12. The electron emission display of claim 11, wherein the adhesive layer comprises a conductive material.

13. The electron emission display of claim 2, wherein the spacers comprise a wall or a pillar shape.

14. A method of manufacturing an electron emission display, the method comprising:
forming phosphor layers on a substrate such that the phosphor layers are surrounded by a non-light emission area;
forming barriers on the non-light emission area such that the barriers are spaced apart from each other;
forming adhesive layers on the non-light emission area surrounded by the barriers; and
mounting spacers on the respective adhesive layers, and pressurizing the spacers such that the adhesive layer entirely covers a surface of the spacers and partially surrounds a lateral surface of the spacer.

15. The method of claim 14, further comprising forming a black layer on the non-light emission area before the formation of the phosphor layers.

16. The method of claim 14, wherein the barriers are formed of an opaque material.

17. The method of claim 14, wherein the barriers are formed by one of screen printing, laminating, or doctor blade processing.
